(19) United States
(12) Patent Application Publication
(10) Pub. No.: US 2012/0249339 A1
(43) Pub. Date: Oct. 4, 2012

(54) UTILITY METER DISPLAY SYSTEM

(75) Inventors: James Patrick Hanley, Decatur, GA (US); Curtis Whitmore Crittenden, Dover, NH (US)

(73) Assignee: GENERAL ELECTRIC COMPANY, Schenectady, NY (US)

(21) Appl. No.: 13/075,482

(22) Filed: Mar. 30, 2011

(51) Int. Cl. G08C 19/16

(52) U.S. Cl. 340/870.02

(57) ABSTRACT

Utility meter display systems are disclosed. In one embodiment, a utility meter display system includes: a bistable display configured to be disposed upon a utility meter; and a computing device communicatively connected to the bistable display and the utility meter, the computing device configured to obtain utility service metrology data from the utility meter and transmit the utility service metrology data to the bistable display.

### BACKGROUND OF THE INVENTION

The subject matter disclosed herein relates generally to meter technology, and more particularly, to display systems for utility meters.

Some utility companies, for example, certain electrical or gas service companies, employ utility meters to assist in tracking and billing customer service consumption. These utility meters monitor the amount of service delivered to and consumed by a given location or consumer and display these metered totals on an energized meter display to be read and recorded by an employee of the utility company and/or the consumer. Each energized meter display is disposed with a nameplate used for meter identification. The nameplate and energized meter display are located behind a secure barrier, such as a secure glass case, on the utility meter. The case may help prevent tampering and protect the integrity of the data held on the energized meter display and the nameplate. The energized meter display is powered by, and obtains data from, the utility meter. The nameplate is specifically machined for each utility meter, having affixed, inscribed or machined into the surface, information such as the serial number for the specific utility meter and the name and/or graphic of the service company who owns and maintains the utility meter. However, these energized meter displays are unable to display meter readings when the meter is de-energized (e.g. during a power outage, when the meter is disconnected, etc.) and also may be continuously consuming energy while displaying data. Further, the nameplates are difficult and time-consuming to manufacture as each nameplate is individually numbered, identified, and matched to a corresponding meter. Additionally, switching of nameplates in the event of an update or a change in service provider, is labor intensive and threatening to the security of the utility meter as it requires removing the secure barrier and subsequently recalibrating and recertifying the utility meter.

### BRIEF DESCRIPTION OF THE INVENTION

Systems for displaying utility meter data are disclosed. In one embodiment, a utility meter display system includes: a bistable display configured to be disposed upon a utility meter; and a computing device communicatively connected to the bistable display and the utility meter, the computing device configured to obtain utility service metrology data from the utility meter and transmit the utility service metrology data to the bistable display.

A first aspect of the invention provides a utility meter display system including: a bistable display configured to be disposed upon a utility meter; and a computing device communicatively connected to the bistable display and the utility meter, the computing device configured to obtain utility service metrology data from the utility meter and transmit the utility service metrology data to the bistable display.

A second aspect of the invention provides a service consumption monitoring system including: a utility meter base coupled to a meter socket, the utility meter base configured to obtain utility service metrology data; a display device communicatively connected to the meter base, the display device configured to display the utility service metrology data obtained from the meter base; and a first bistable display communicatively connected to the meter base, the first bistable display configured to display nameplate data for the utility meter.

A third aspect of the invention provides a utility meter including: a meter base coupled to a meter socket, the meter base configured to obtain utility service metrology data; and a first bistable display communicatively connected to the meter base, the first bistable display configured to obtain and display the utility service metrology data obtained by the meter base.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic illustration of a service consumption monitoring system in accordance with an embodiment of the invention.

FIG. 2 shows a schematic illustration of a utility meter in accordance with an embodiment of the invention.

FIG. 3 shows a schematic illustration of a utility meter in accordance with an embodiment of the invention.

FIG. 4 shows a schematic illustration of a utility meter in accordance with an embodiment of the invention.

It is noted that the drawings of the disclosure may not be to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As indicated above, aspects of the invention provide for systems configured to display utility service metrology data via a bistable display. The bistable display is configured to obtain utility service metrology data (including, e.g. an amount of service consumed, a service demand, a power factor, a reactive power, an amount of charge used, a volumetric flow rate, a net-metering of import and export, 4-quadrant metering values, minimum and maximum voltages observed, minimum and maximum currents observed, KiloWatts (KW) imported, KW Exported, Kilovolt-Ampere-Reactance (KVAr) for each quadrant, active energy imported, active energy exported, reactive power for each quadrant, net active energy, block demand calculations, rolling demand calculations and subintervals, status of reset for the demand registers, pulsed output status to signal consumption of active and reactive power, time of use (TOU) status, cost of service used in the current billing period, peak demand, status of last TOU register reset, TOU timetable information, TOU clock and calendar information, TOU contract information, remote disconnect switch status, voltage status, frequency status, cover removal status, cover tamper status, cover bypass status, load control status, prepay service status and event log (along with a Date/Time stamp), low balance flag status, communication status, etc.) from a utility meter and display the utility service metrology data in a substantially de-energized state. The bistable display may obtain and display metrology and/or nameplate data from the utility meter via a computing device integrated with, or external to, the utility meter. The computing device may regularly update metrology and/or nameplate data displayed on the bistable display. This provides a securely updateable utility meter which may consume power intermittently and which may be continuously readable even in a de-energized state. As a result, the utility company is able to easily update the nameplate for the utility meter without opening the secure seal, improve the versatility and readability of the display on the utility meter, and reduce the amount of power required to drive the utility meter.

In the art of metered services and systems, utility meters (including, e.g., electrical meters, smart meters, power meters, gas meters, etc.) are used to measure, record and display the amount of service consumed by customers and meter locations. Typically, these utility meters display identification and utility service metrology data by employing a combination of an energized digital display for updating and displaying utility service metrology data, and a physical nameplate for displaying meter and service provider identification. Conventionally, both the energized display and the physical nameplate are contained behind a secure glass case in the utility meter. However, the use of meter-specific physical nameplates may increase manufacturing and updating demands. Additionally, the use of an energized digital display may consume energy and render the meter unable to display utility service metrology data any time the meter is de-energized. Further, the placement of the meter-specific physical nameplate within the secure glass case may complicate and increase the cost of nameplate data updates.

In contrast to conventional systems, embodiments of the current invention provide for a utility meter which displays metrology and/or nameplate data via at least one secure display. The at least one secure display, uses less power when driving the display, is readable while de-energized and is simple to update and install. The utility meter utilizes a bistable display (including, e.g., Electrofluidic Display (EFD) Technology, a Polymer Stabilized Cholesteric Liquid Crystals (Kent Display) ChLCD screen, a Ferro Liquid Display, a Ferro Fluid Display, a Ferro-electric Liquid Display, etc.) to display metrology and/or nameplate data obtained from the meter base of the utility meter. The bistable display may consume energy when data is being updated and intermittently or not at all while displaying the metrology and/or nameplate data, thereby reducing the energy footprint of the utility meter. As the bistable display may not consume power while displaying data, the metrology and/or nameplate data may remain readable even when the utility meter has been pulled by a technician or power is not available. Updating of nameplate data on the bistable display may be accomplished via the meter base without removing the secure seal or disconnecting the utility meter or meter base from the meter socket and without recalibrating the utility meter.

As will be appreciated by one skilled in the art, the utility meter and display system described herein may be embodied as a system(s), method(s) or computer program product(s), e.g., as part of a utility network or utility meter system. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “network” or “system.” Furthermore, the present invention may take the form of a computer program product embodied in any tangible medium of expression having computer-usable program code embodied in the medium.

Any combination of one or more computer usable or computer readable medium(s) may be utilized. The computer-useable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

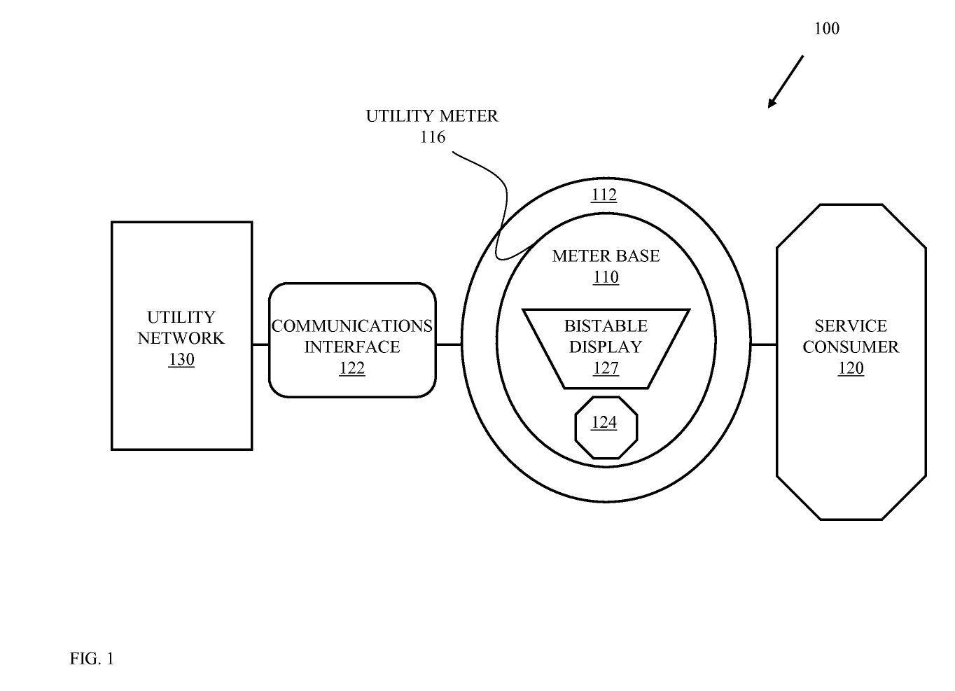

Turning to the Figures, embodiments of a utility meter display system are shown, where the display system may display metrology and/or nameplate data in a substantially de-energized state. Thereby simplifying the manufacturing and updating processes for the utility meter and providing a substantially continuous data display. Each of the components in the Figures may be connected via conventional means, e.g., via wireless mesh, WiFi, power line communication, cellular, wire transmission or other known means as is indicated in the FIGS. 1-4. Specifically, referring to FIG. 1, a schematic illustration of an embodiment of a service consumption monitoring system 100 is shown according to embodiments of the invention. Service consumption monitoring system 100 may include a utility meter 116 communicatively connected to a utility meter socket 112. Utility meter 116 may include a meter base 110 configured to monitor service consumption of a service consumer 120 (including, e.g., a house, a business, a device, etc.) supported by a utility network 130. Utility meter 116 may include an electrical meter, a water meter, a gas meter, a smart meter or any other form of utility meter as is known in the art. In this embodiment of the invention, utility meter 116 includes meter base 110 which generates utility service metrology data by monitoring the delivery of service from utility network 130 to service consumer 120 via utility socket 112. Utility meter 116 may further include a computing device 124 which may be communicatively connected to meter base 110 and a bistable display 127. Computing device 124 obtains the utility service metrology data from meter base 110 and transmits the utility service metrology data to bistable display 127 for display. Bistable display 127 displays the utility service metrology data in a de-energized state as any combination of letters, numbers, symbols or figures. This de-energized display of data enables utility meter 116 to be readable in the event of a power outage and to consume power when utility service metrology data is updated but not necessarily while driving bistable display 127.

In an embodiment of the present invention, computing device 124 may update utility service metrology data displayed on bistable display 127. In one embodiment of the invention, bistable display 127 may be continuously readable, displaying utility service metrology data during a loss of power or when meter base 110 is disconnected from utility meter socket 112 or any other form of power supply. In another embodiment, bistable display 127 may display nameplate data (including, e.g. a utility company name, a utility company graphic, a meter serial number, nameplate artwork, an adjustable linear barcode, an adjustable matrix barcode, an adjustable barcode displaying encrypted metrology data, an installed automated metering infrastructure vendor technology identity, a meter leasing company identity, a meter reading company identity, etc.) in addition to utility service metrology data.

In one embodiment, nameplate data may be stored on (e.g., in a conventional memory), or obtained from, computing device 124. In another embodiment, meter base 110 may include a processor, a memory, a computer readable medium and/or any other form of computing apparatus as is known in the art. In one embodiment, nameplate data may be stored on, or obtained from, meter base 110. In another embodiment, at least one of computing device 124 and meter base 110 may utilize a communications interface 122 (including, e.g. low-power digital radio, power line communication, wireless local area network, etc.) to communicate with utility network 130, receiving firmware and/or nameplate data updates. Computing device 124 and/or meter base 110 may update nameplate data on bistable display 127 in response to obtaining an update of the nameplate data from utility network 130 via communications interface 122. In an embodiment of the present invention, computing device 124 may be integrated with meter base 110. In another embodiment, computing device 124 may be an existing meter processor on meter base 110.

In any event, computing device 124 can comprise any general purpose computing article of manufacture capable of executing computer program code installed by a user (e.g., a personal computer, server, handheld device, etc.). However, it is understood that computing device 124 is only representative of various possible equivalent computing devices that may perform the various process steps of the disclosure. To this extent, in other embodiments, computing device 124 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

As previously mentioned and discussed further below, service consumption monitoring system 100, display system 202, display system 302 and display system 402 have the technical effect of enabling utility meter 116 to perform, among other things, the service consumption monitoring and display functions described herein. It is understood that some of the various components shown in FIG. 1 can be implemented independently, combined, and/or stored in memory for one or more separate computing devices that are included in computing device 124. Further, it is understood that some of the components and/or functionality may not be implemented, or additional schemas and/or functionality may be included as part of utility meter 116.

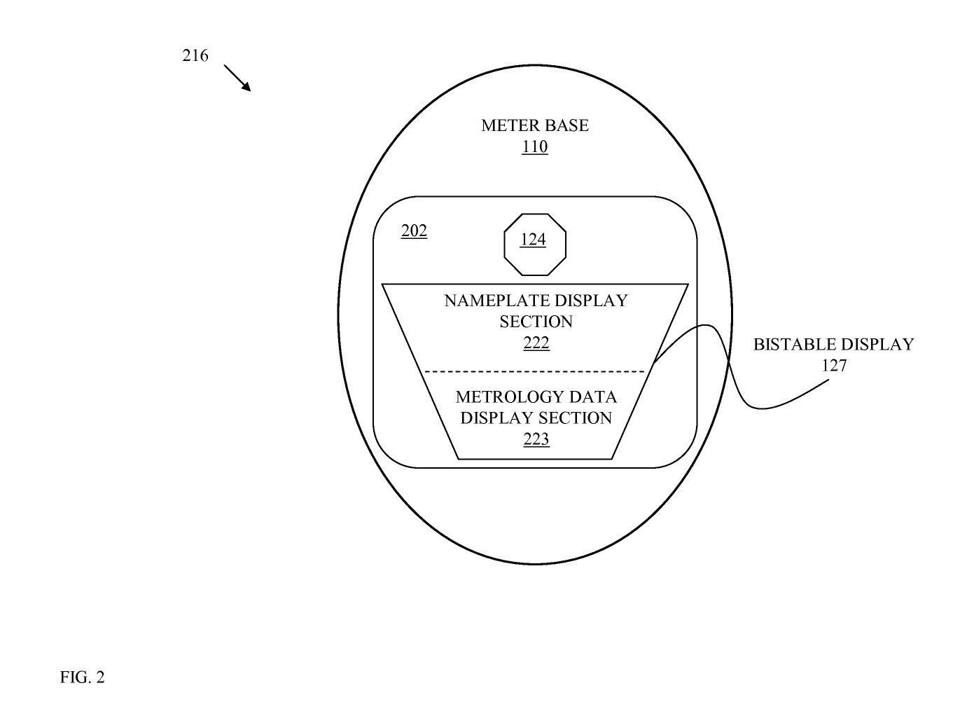

Turning to FIG. 2, a schematic illustration of an embodiment of a utility meter 216 including a meter base 110 and a display system 202 is shown. It is understood that elements similarly numbered between FIG. 1 and FIG. 2 may be substantially similar as described with reference to FIG. 1. Redundant explanation of these elements has been omitted for clarity. Returning to FIG. 2, in this embodiment, display system 202 may be disposed upon meter base 110 and include a bistable display 127 communicatively connected to meter base 110 and/or computing device 124. Bistable display 127 may be configured with a utility service metrology data display section 223 to display utility service metrology data obtained from meter base 110 via computing device 124. In another embodiment, bistable display 127 may be configured with a nameplate display section 222 (shown in phantom) configured to display nameplate data for meter base 110. In one embodiment, bistable display 127 may include both nameplate display section 222 and utility service metrology data display section 223. In one embodiment, nameplate display section 222 may be substantially contiguous with utility service metrology data display section 223. In another embodiment, nameplate display section 222 and utility service metrology data display section 223 may be visually distinct from one another.

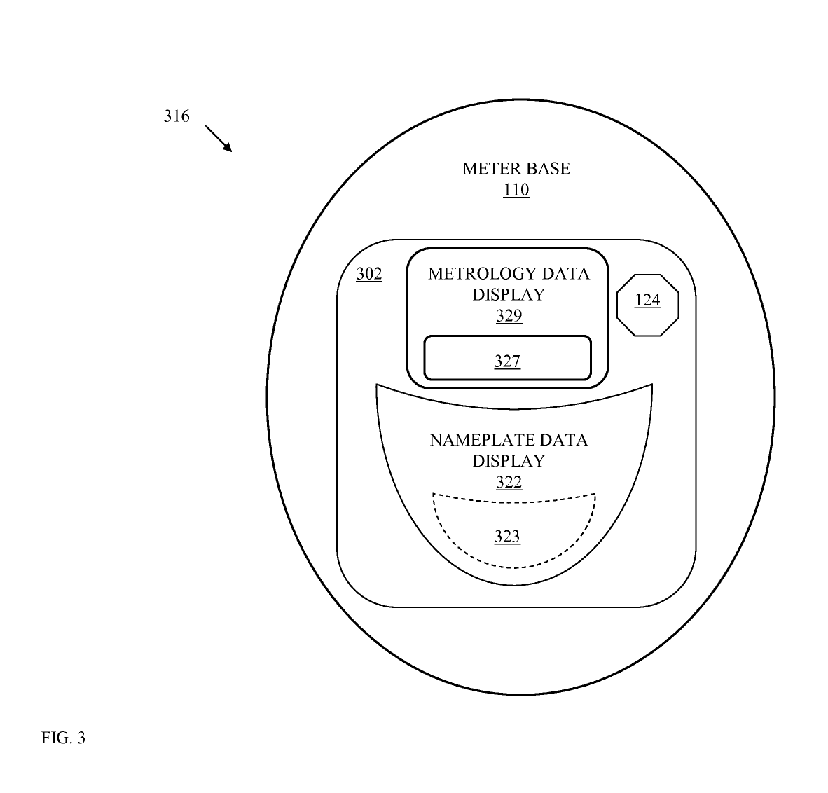

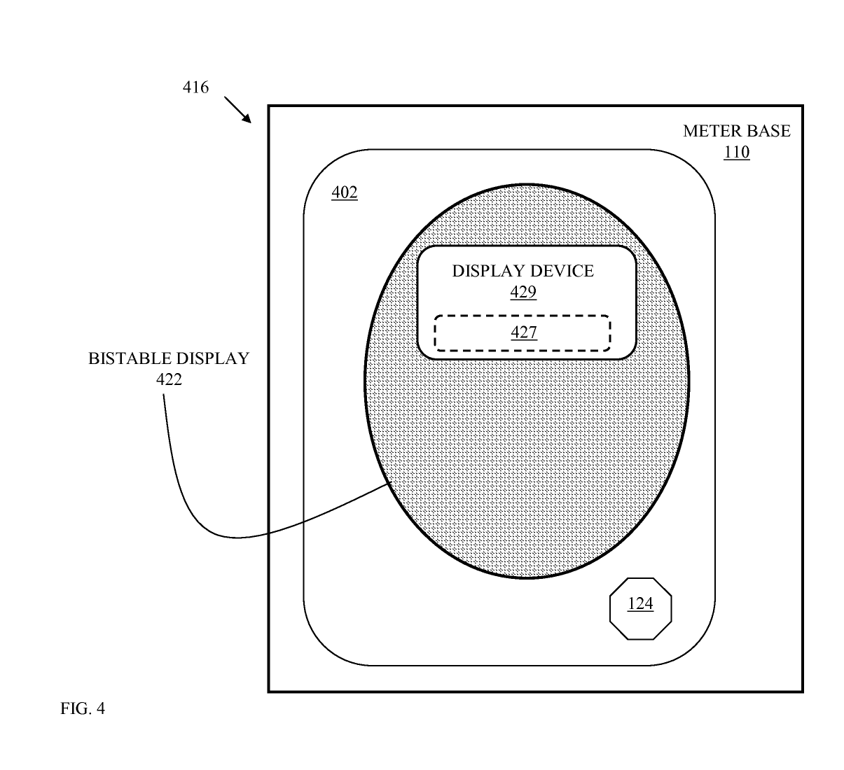

Turning to FIG. 3, a schematic illustration of an embodiment of a utility meter 316 is shown including a display system 302 disposed upon meter base 110. In this embodiment, display system 302 includes a utility service metrology data display 329 and a separate nameplate data display 322, both communicatively connected to meter base 110 and/or computing device 124. In an embodiment, utility service metrology data display 329 may include a first bistable display 327 configured to display metrology data, and nameplate data display 322 may include a heat-tempered sticker, machined data plate etc. In another embodiment, utility service metrology data display 329 may include first bistable display 327 configured to display utility service metrology data and nameplate data display 322 may include a separate second bistable display 323 (shown in phantom) configured to display nameplate data. In one embodiment, utility service metrology data display 329 and nameplate data display 322 may be integrated with meter base 110. In another embodiment, utility service metrology data display 329 and nameplate data display 322 may be directly physically connected to meter base 110. Turning to FIG. 4, a schematic illustration of a utility meter 416 is shown having a display system 402 disposed upon meter base 110. In this embodiment, display system 402 includes a first bistable display 422 communicatively connected to computing device 124 and/or meter base 110, first bistable display 422 configured to display nameplate data for utility meter 416. In one embodiment of the invention, display system 402 may include a display device 429 configured to display utility service metrology data obtained from either or both of computing device 124 and meter base 110. In another embodiment, display device 429 may be a digital display. In another embodiment, display device 429 may be an electromechanical device. In another embodiment, display device 429 may include a second bistable display 427 (shown in phantom). In one embodiment, display system 402 may be physically installed upon meter base 110.

The display system of the present disclosure is not limited to any one particular meter, electrical meter, smart meter, network or other system, and may be used with other power and communication systems. Additionally, the display system of the present invention may be used with other systems not described herein that may benefit from the versatile, secure, substantially de-energized data display provided by the display system described herein.

As discussed herein, various systems and components are described as “obtaining” data (e.g., utility service metrology data, nameplate data, etc.). It is understood that the corresponding data can be obtained using any solution. For example, the corresponding system/component can generate and/or be used to generate the data, retrieve the data from one or more data stores or sensors (e.g., a database), receive the data from another system/component, and/or the like. When the data is not generated by the particular system/component, it is understood that another system/component can be implemented apart from the system/component shown, which generates the data and provides it to the system/component and/or stores the data for access by the system/component.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A utility meter display system comprising:
a bistable display configured to be disposed upon a utility meter; and
a computing device communicatively connected to the bistable display and the utility meter, the computing device configured to obtain utility service metrology data from the utility meter and transmit the utility service metrology data to the bistable display.

2. The utility meter display system of claim 1, wherein the bistable display is continuously readable.

3. The utility meter display system of claim 1, wherein the utility service metrology data displayed on the bistable display includes at least one of: an amount of service consumed, a service demand, a power factor, a reactive power, an amount of charge used, a volumetric flow rate, a net-metering of import and export, 4-quadrant metering values, minimum and maximum voltages observed, minimum and maximum currents observed, KiloWatts (KW) imported, KW Exported, Kilovolt-Ampere-Reactance (KVAr), active energy imported, active energy exported, reactive power, net active energy, block demand calculations, rolling demand calculations and subintervals, status of reset for the demand registers, pulsed output status to signal consumption of active and reactive power, time of use (TOU) status, cost of service used in the current billing period, peak demand, status of last TOU register reset, TOU timetable information, TOU clock and calendar information, TOU contract information, remote disconnect switch status, voltage status, frequency status, cover removal status, cover tamper status, cover bypass status, load control status, prepay service status and event log, low balance flag status, and communication status.

4. The utility meter display system of claim 1, wherein the computing device is further configured to update the utility service metrology data displayed on the bistable display.

5. The utility meter display system of claim 1, wherein the bistable display is further configured to display nameplate data for the utility meter.

6. The utility meter display system of claim 5, further comprising a communications interface communicatively connected to the computing device, the communications interface configured to enable the computing device to obtain at least one of a firmware update and an update of the nameplate data.

7. The utility meter display system of claim 5, wherein the nameplate data for the utility meter includes at least one of: a utility company name, a utility company graphic, a meter serial number, nameplate artwork, an adjustable linear barcode, an adjustable matrix barcode, an adjustable barcode displaying encrypted metrology data, an installed automated metering infrastructure vendor technology identity, a meter leasing company identity, a meter reading company identity

8. The utility meter display system of claim 1, wherein the computing device includes a meter processor.

9. A service consumption monitoring system comprising:
a utility meter base coupled to a meter socket, the utility meter base configured to obtain utility service metrology data;
a display device communicatively connected to the meter base, the display device configured to display the utility service metrology data obtained from the meter base; and
a first bistable display communicatively connected to the meter base, the first bistable display configured to display nameplate data for the meter base.

10. The service consumption monitoring system of claim 9, wherein the first bistable display is continuously readable.

11. The service consumption monitoring system of claim 9, wherein the nameplate data for the utility meter includes at least one of: a utility company name, a utility company graphic, a meter serial number, nameplate artwork, an adjustable linear barcode, an adjustable matrix barcode, an adjustable barcode displaying encrypted metrology data, an installed automated metering infrastructure vendor technology identity, a meter leasing company identity, a meter reading company identity

12. The service consumption monitoring system of claim 9, further comprising a communications interface communicatively connected to the meter base, the communications interface configured to enable the meter base to obtain at least one of a firmware update and an update of the nameplate data.

13. The service consumption monitoring system of claim 9, wherein the display device includes a second bistable display, the second bistable display configured to display the utility service metrology data.

14. The service consumption monitoring system of claim 13, wherein the meter base is further configured to update the utility service metrology data displayed on the second bistable display.

15. A utility meter comprising:
a meter base coupled to a meter socket, the meter base configured to obtain utility service metrology data; and
a first bistable display communicatively connected to the meter base, the first bistable display configured to obtain and display the utility service metrology data obtained by the meter base.

16. The utility meter of claim 15, wherein the utility service metrology data displayed on the first bistable display includes at least one of: an amount of service consumed, a service demand, a power factor, a reactive power, an amount of charge used, a volumetric flow rate, a net-metering of import and export, 4-quadrant metering values, minimum and maximum voltages observed, minimum and maximum currents observed, KiloWatts (KW) imported, KW Exported, Kilovolt-Ampere-Reactance (KVAr), active energy imported, active energy exported, reactive power, net active energy, block demand calculations, rolling demand calculations and subintervals, status of reset for the demand registers, pulsed output status to signal consumption of active and reactive power, time of use (TOU) status, cost of service used in the current billing period, peak demand, status of last TOU register reset, TOU timetable information, TOU clock and calendar information, TOU contract information, remote disconnect switch status, voltage status, frequency status, cover removal status, cover tamper status, cover bypass status, load control status, prepay service status and event log, low balance flag status, and communication status.

17. The utility meter of claim 15, wherein the meter base is further configured to update the utility service metrology data displayed on the first bistable display.

18. The utility meter of claim 15, further comprising a second bistable display communicatively connected to the meter base, the second bistable display configured to display nameplate data for the utility meter.

19. The utility meter of claim 18, further comprising a communications interface communicatively connected to the meter base, the communications interface configured to enable the meter base to obtain at least one of a firmware update and an update of the nameplate data.

20. The utility meter of claim 18, wherein the nameplate data for the utility meter includes at least one of: a utility company name, a utility company graphic, a meter serial number, nameplate artwork, an adjustable linear barcode, an adjustable matrix barcode, an adjustable barcode displaying encrypted metrology data, an installed automated metering infrastructure vendor technology identity, a meter leasing company identity, a meter reading company identity
